(19) United States
(12) Patent Application Publication
(10) Pub. No.: US 2015/0372440 A1
(43) Pub. Date: Dec. 24, 2015

(54) SHORT OPTICAL PULSE GENERATING APPARATUS, TERAHERTZ WAVE GENERATING APPARATUS, CAMERA, IMAGING APPARATUS, AND MEASURING APPARATUS

(71) Applicant: SEIKO EPSON CORPORATION, Tokyo (JP)

(72) Inventor: Hitoshi NAKAYAMA, Chino-shi (JP)

(21) Appl. No.: 14/748,053

(22) Filed: Jun. 23, 2015

(30) Foreign Application Priority Data
Jun. 24, 2014 (JP) 2014-129024

(51) Int. Cl. H01S 3/00; G02B 5/18; H04N 5/30; G02F 1/017; G02F 1/355; G01J 5/10; G02B 1/11

(52) U.S. Cl. CPC H01S 3/0057; H01S 3/0064; G01J 5/10; G02B 5/1861; G02B 5/1814; G02B 1/11; G02F 1/017; G02F 1/3556; H04N 5/30

(57) ABSTRACT

A short optical pulse generating apparatus includes: an optical pulse generating portion that generates an optical pulse; and a pulse compressing portion to which the optical pulse is incident and that decreases the pulse width of the optical pulse, wherein the pulse compressing portion includes a quantum well layer, group velocity dispersion layers that are stacked to interpose the quantum well layer therebetween and are formed with a group velocity dispersion medium, and reflective layers that are provided to interpose the quantum well layer and the group velocity dispersion layers in a stacking direction of the quantum well layer and the group velocity dispersion layers.

### BACKGROUND

1. Technical Field

The present invention relates to a short optical pulse generating apparatus, a terahertz wave generating apparatus, a camera, an imaging apparatus, and a measuring apparatus.

2. Related Art

Recently, terahertz waves that are electromagnetic waves having a frequency in the range of 100 GHz to 30 THz are attracting attention. The terahertz wave can be used, for example, for various kinds of measurements such as imaging or stereoscopic measurement, nondestructive inspection, and the like.

A terahertz wave generating apparatus that generates the terahertz waves include, for example, a short optical pulse generating apparatus that generates an optical pulse having a pulse width of about sub-picoseconds (several hundreds femtoseconds) and a photoconductive antenna that generates the terahertz waves by the application of the optical pulse generated in the short optical pulse generating apparatus. In general, as the short optical pulse generating apparatus that generates an optical pulse having a pulse width of about sub-picoseconds, a femtosecond fiber laser, a titanium sapphire laser, a semiconductor laser, and the like are used.

For example, JP-A-11-40889 discloses an optical pulse generating apparatus that chirps a frequency of the optical pulse by directly modulating a semiconductor laser, and then compresses a pulse width in a pulse compressing portion (group velocity dispersion portion) formed of a fiber.

However, in the optical pulse generating apparatus disclosed in JP-A-11-40889, since the frequency of the optical pulse is chirped by directly modulating the semiconductor laser, the chirp quantity is small and the pulse width may not be sufficiently compressed in the group velocity dispersion portion.

### SUMMARY

An advantage of some aspects of the invention is to provide a short optical pulse generating apparatus that causes an optical pulse having a small pulse width to be generated. In addition, an advantage of some aspects of the invention is to provide a terahertz wave generating apparatus, a camera, an imaging apparatus, and a measuring apparatus including the short optical pulse generating apparatus.

A short optical pulse generating apparatus according to an aspect of the invention includes an optical pulse generating portion that generates an optical pulse; and a pulse compressing portion to which the optical pulse is incident and that decreases the pulse width of the optical pulse, in which the pulse compressing portion includes a quantum well layer, group velocity dispersion layers that are stacked to interpose the quantum well layer therebetween and is formed with a group velocity dispersion medium, and reflective layers that are provided to interpose the quantum well layer and the group velocity dispersion layers in a stacking direction of the quantum well layer and the group velocity dispersion layers.

In the short optical pulse generating apparatus, since the pulse compressing portion includes a quantum well layer, the frequency of the optical pulse that passes through the quantum well layer can be chirped. Accordingly, in the short optical pulse generating apparatus, compared with a form in which a pulse compressing portion does not have a quantum well layer, the chirp quantity of the optical pulse can be caused to be great and thus the pulse width can be sufficiently compressed in the group velocity dispersion layer. Accordingly, the short optical pulse generating apparatus can generate an optical pulse having a small pulse width.

In the short optical pulse generating apparatus according to the aspect of the invention, the group velocity dispersion layers may be formed of a semiconductor.

In the short optical pulse generating apparatus with this configuration, the quantum well layer and the group velocity dispersion layer can be formed by epitaxial growth. Therefore, in the short optical pulse generating apparatus, the pulse compressing portion can be easily manufactured.

In the short optical pulse generating apparatus according to the aspect of the invention, the reflective layer may be a distribution Bragg reflection-type mirror.

In the short optical pulse generating apparatus with this configuration, the reflective layer can be formed by epitaxial growth by alternately stacking high refractive index layers and low refractive index layers. Therefore, in the short optical pulse generating apparatus, the pulse compressing portion can be easily manufactured.

In the short optical pulse generating apparatus according to the aspect of the invention, the optical pulse may be incident to the pulse compressing portion in a direction oblique to the stacking direction.

In the short optical pulse generating apparatus with this configuration, the pulse compressing portion can cause the optical pulse to be reflected between the reflective layers plural times and to be emitted. Accordingly, in the pulse compressing portion, the application of the frequency chirp to the optical pulse and the pulse compression can be repeated, and the optical pulse having a small pulse width can be generated.

In the short optical pulse generating apparatus according to the aspect of the invention, an antireflection film may be provided in an incident portion to which the optical pulse of the pulse compressing portion is incident.

In the short optical pulse generating apparatus with this configuration, the reflectivity in the incident portion can be caused to be low.

The short optical pulse generating apparatus according to the aspect of the invention may further include an electrode that applies a reverse bias to the pulse compressing portion.

In the short optical pulse generating apparatus with this configuration, the absorption characteristic of the quantum well layer can be controlled, and thus the chirp quantity of the frequency of the optical pulse can be adjusted. Further, in the short optical pulse generating apparatus, a group velocity dispersion value of the group velocity dispersion layer can be controlled.

The short optical pulse generating apparatus according to the aspect of the invention may further include an incident angle changing mechanism that changes an incident angle of the optical pulse to the pulse compressing portion.

In the short optical pulse generating apparatus with this configuration, the number of times of the reflection of the optical pulse on the reflective layer can be changed. As a result, in the short optical pulse generating apparatus, the chirp quantity of the optical pulse and the group velocity dispersion value of the group velocity dispersion portion can be changed, and thus the pulse width of the optical pulse that is generated in the short optical pulse generating apparatus can be changed.

The short optical pulse generating apparatus according to the aspect of the invention may further include a collimating lens that converts the optical pulse that is incident to the pulse compressing portion to parallel light.

In the short optical pulse generating apparatus with this configuration, the diffusion of the optical pulse that is incident to the pulse compressing portion can be suppressed.

A terahertz wave generating apparatus according to another aspect of the invention includes the short optical pulse generating apparatus according to the aspect of the invention; and a photoconductive antenna to which the short optical pulse that is generated in a short optical pulse generating apparatus is applied and which causes terahertz waves to be generated.

The terahertz wave generating apparatus can include the short optical pulse generating apparatus that can generate the optical pulse having a small pulse width.

A camera according to still another aspect of the invention includes the short optical pulse generating apparatus according to the aspect of the invention; a photoconductive antenna to which the short optical pulse that is generated in a short optical pulse generating apparatus is applied and which causes terahertz waves to be generated; a terahertz wave detecting portion that detects the terahertz waves that are emitted from the photoconductive antenna and permeate an object or the terahertz waves that are reflected on an object; and a memory unit that stores a detection result of the terahertz wave detecting portion.

The camera can include the short optical pulse generating apparatus that can generate the optical pulse having a small pulse width.

An imaging apparatus according to yet another aspect of the invention includes the short optical pulse generating apparatus according to the aspect of the invention; a photoconductive antenna to which the short optical pulse that is generated in a short optical pulse generating apparatus is applied and which causes terahertz waves to be generated; a terahertz wave detecting portion that detects the terahertz waves that are emitted from the photoconductive antenna and permeate an object or the terahertz waves that are reflected on an object; and an image forming portion that generates an image of the object based on a detection result of the terahertz wave detecting portion.

The imaging apparatus can include a short optical pulse generating apparatus that can generate the optical pulse having a small pulse width.

A measuring apparatus according to still yet another aspect of the invention includes the short optical pulse generating apparatus according to the aspect of the invention; a photoconductive antenna to which the short optical pulse that is generated in a short optical pulse generating apparatus is applied and which causes terahertz waves to be generated; a terahertz wave detecting portion that detects the terahertz waves that are emitted from the photoconductive antenna and permeate an object or the terahertz waves that are reflected on an object; and a measuring portion that measures the object based on a detection result of the terahertz wave detecting portion.

The measuring apparatus can include a short optical pulse generating apparatus that can generate the optical pulse having a small pulse width.

### BRIEF DESCRIPTION OF THE DRAWINGS

The invention will be described with reference to the accompanying drawings, wherein like numbers reference like elements.

FIG. 1 is a diagram schematically illustrating a short optical pulse generating apparatus according to the embodiment.

FIG. 2 is a graph illustrating an example of an optical pulse generated in an optical pulse generating portion.

FIG. 3 is a graph illustrating an example of a chirp characteristic of a quantum well layer.

FIG. 4 is a graph illustrating an example of an optical pulse generated in the pulse compressing portion.

FIG. 5 is a graph illustrating an example of an optical pulse generated in the pulse compressing portion.

FIG. 6 is a diagram schematically illustrating a short optical pulse generating apparatus according to a first modification example of the embodiment.

FIG. 7 is a diagram schematically illustrating a short optical pulse generating apparatus according to a second modification example of the embodiment.

FIG. 8 is a diagram schematically illustrating a model for describing an incident angle of the optical pulse to the pulse compressing portion and a relationship between a chirp quantity and a group velocity dispersion value.

FIG. 9 is a graph illustrating a relationship between an incident angle of the optical pulse to a semiconductor saturable absorption mirror and a group velocity dispersion value.

FIG. 10 is a diagram illustrating a configuration of a terahertz wave generating apparatus according to the embodiment.

FIG. 11 is a block diagram illustrating an imaging apparatus according to the embodiment.

FIG. 12 is a plan view schematically illustrating a terahertz wave detecting portion of the imaging apparatus according to the embodiment.

FIG. 13 is a graph illustrating a spectrum in the terahertz band of an object.

FIG. 14 is a diagram illustrating an image showing distribution of media A, B, and C of the object.

FIG. 15 is a block diagram illustrating a measuring apparatus according to the embodiment.

FIG. 16 is a block diagram illustrating a camera according to the embodiment.

FIG. 17 is a perspective view schematically illustrating the camera according to the embodiment.

### DESCRIPTION OF EXEMPLARY EMBODIMENTS

Hereinafter, preferred embodiments of the invention are described in detail with reference to the drawings. In addition, the embodiments described below are not intended to limit the contents of the invention. In addition, not all of the configurations described below are essential.

### 1. Short Optical Pulse Generating Apparatus

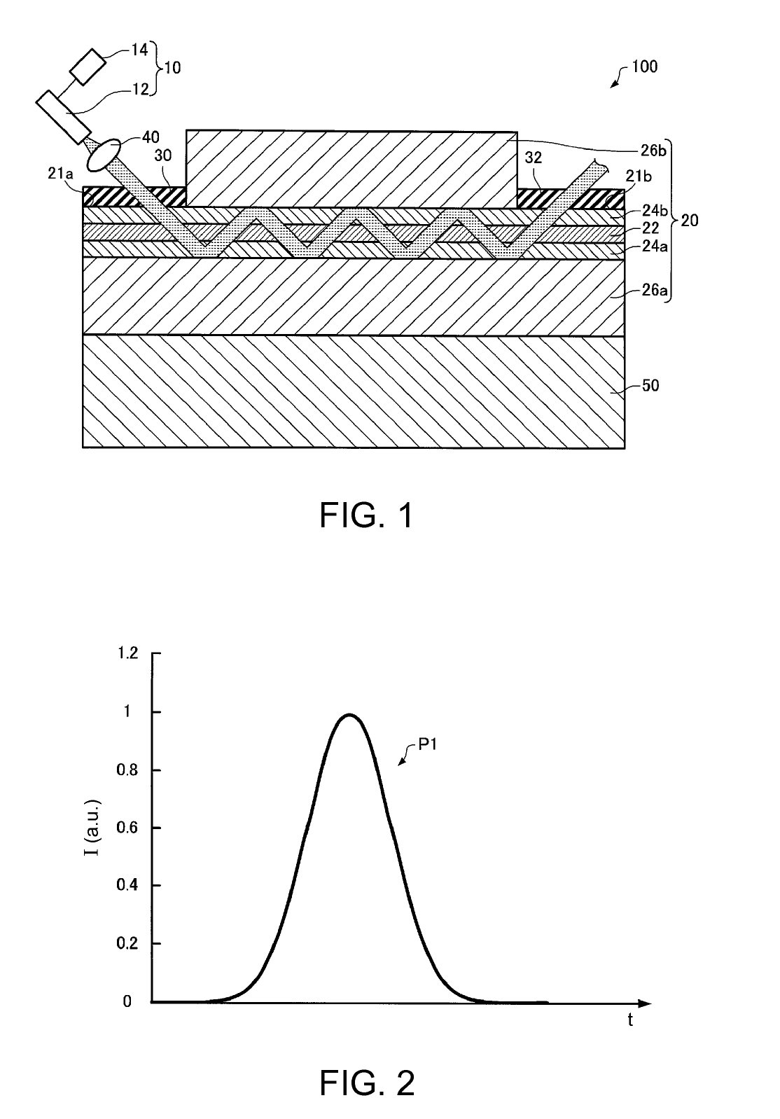

First, a short optical pulse generating apparatus according to the embodiment is described with reference to the drawings. FIG. 1 is a diagram schematically illustrating a short optical pulse generating apparatus 100 according to the embodiment.

As illustrated in FIG. 1, the short optical pulse generating apparatus 100 includes an optical pulse generating portion 10, a pulse compressing portion 20, antireflection films 30 and 32, a collimating lens 40, and a supporting substrate 50.

The optical pulse generating portion 10 generates an optical pulse. Here, the optical pulse refers to light of which the intensity sharply changes in a short period of time. The pulse width (full width at half maximum FWHM) of the optical pulse generated by the optical pulse generating portion 10 is, for example, in the range of 1 ps (picosecond) to 100 ps. The optical pulse generating portion 10 includes, for example, a light emitting element 12 and a drive circuit 14. The light emitting element 12 is, for example, a semiconductor laser and a super luminescent diode (SLD).

A drive circuit 14 drives a light emitting element 12 by direct modulation. Here, the direct modulation refers to a method of using a modulating signal in a driving electric current for causing the light emitting element 12 to generate an optical pulse. In the optical pulse generating portion 10, the optical pulse is generated by the light emitting element 12 driven by the drive circuit 14.

The optical pulse generating portion 10 (the light emitting element 12) is arranged so that the optical pulse generated by the optical pulse generating portion 10 is incident to the pulse compressing portion 20 in a direction oblique to the stacking direction of a quantum well layer 22 and group velocity dispersion layers 24a and 24b that form the pulse compressing portion 20. That is, the optical pulse is incident to the pulse compressing portion 20 in the direction oblique to the stacking direction of the quantum well layer 22 and the group velocity dispersion layers 24a and 24b. The optical pulse is incident in a direction oblique to an incident portion 21a of the pulse compressing portion 20 (an upper surface of a second group velocity dispersion layer 24b), and the incident angle of the optical pulse is greater than 0° and less than 90°.

The pulse compressing portion 20 is smaller than the pulse width of the optical pulse generated in the optical pulse generating portion 10. The pulse compressing portion 20 includes the quantum well layer 22, a first group velocity dispersion layer 24a, the second group velocity dispersion layer 24b, a first reflective layer 26a, and a second reflective layer 26b.

The quantum well layer 22 includes, for example, a quantum well structure formed of a semiconductor material. The quantum well structure refers to a general quantum well structure in the field of a semiconductor luminescent apparatuses, and has a structure in which two or more materials having different band gaps are used, and a thin film (nm order) formed of a material having a smaller band gap is sandwiched with thin films having a greater band gap. The quantum well layer 22 has a multiquantum well structure in which three quantum well structures formed of a GaAs layer and an AlGaAs layer are overlapped.

If an optical pulse passes through the quantum well layer 22, the refractive index of the quantum well layer 22 changes by an optical Carr effect, and a phase of an electric field changes (self-phase modulation effect). The frequency of the optical pulse is chirped by the self-phase modulation effect. Here, the chirping of the frequency refers to the change of the frequency of the optical pulse with time.

Since the quantum well layer 22 is formed of a semiconductor material, the response speed to the optical pulse having the pulse width in the range of 1 ps to 100 ps is slow. Therefore, in the quantum well layer 22, the frequency of the optical pulse is chirped (up-chirped or down-chirped) in proportion to the strength of the optical pulse (square of electric field amplitude). Here, the up-chirp refers to a case in which the frequency of the optical pulse increases with time, and the down-chirp refers to a case in which the frequency of the optical pulse decreases with time. In other words, the up-chirp refers to a case in which the wavelength of the optical pulse becomes short with time, and the down-chirp refers to a case in which the wavelength of the optical pulse becomes long with time.

The first group velocity dispersion layer 24a and the second group velocity dispersion layer 24b are stacked with the quantum well layer 22 interposed therebetween. In the example illustrated in the drawings, the quantum well layer 22 is formed on the first group velocity dispersion layer 24a, and the second group velocity dispersion layer 24b is formed on the quantum well layer 22. The film thickness of the first group velocity dispersion layer 24a and the film thickness of the second group velocity dispersion layer 24b are, for example, the same. In addition, the film thickness of the first group velocity dispersion layer 24a and the film thickness of the second group velocity dispersion layer 24b may be different.

The group velocity dispersion layers 24a and 24b generate a group velocity difference according to the wavelength with respect to the optical pulse of which the frequency is chirped in the quantum well layer 22. Specifically, the group velocity dispersion layers 24a and 24b perform the pulse compression by generating the group velocity difference in which the pulse width of the optical pulse decreases with respect to the optical pulse of which the frequency is chirped.

The group velocity dispersion layers 24a and 24b are formed of the group velocity dispersion medium that causes the optical pulse to generate group velocity dispersion. Here, the group velocity dispersion refers to a phenomenon in which the propagation velocity of the optical pulse is different according to wavelength and the group velocity changes depending on the frequency.

The group velocity dispersion layers 24a and 24b are, for example, semiconductor layers and have a positive group velocity dispersion characteristic. The group velocity dispersion layers 24a and 24b are, for example, AlGaAs layers. Since the group velocity dispersion layers 24a and 24b have a positive group velocity dispersion characteristic, the positive group velocity dispersion is generated in the down-chirped optical pulse so that the pulse width decreases. In this manner, in the group velocity dispersion layers 24a and 24b, the pulse compression is generated based on the group velocity dispersion. After the optical pulse is compressed by the pulse compressing portion 20, the pulse width of the optical pulse emitted from the short optical pulse generating apparatus 100 is not particularly limited, and may be in the range of 1 fs (femtosecond) to 800 fs.

In addition, the positive group velocity dispersion refers to a phenomenon in which the group velocity becomes faster as the wavelength becomes longer. In other words, the positive group velocity dispersion refers to a phenomenon in which the group velocity becomes faster.

The group velocity dispersion layers 24a and 24b are not limited to the semiconductor layer, as long as the group velocity dispersion layers 24a and 24b are formed of the group velocity dispersion medium. For example, the group velocity dispersion layers 24a and 24b may be formed of glass, ceramics, sapphire, or the like. In addition, the group velocity dispersion layers 24a and 24b may have a negative group velocity dispersion characteristic. Here, the negative group velocity dispersion refers to a phenomenon in which the group velocity becomes slower as the wavelength becomes longer. In other words, the negative group velocity dispersion refers to a phenomenon in which the group velocity becomes slower, as the frequency becomes lower.

The first reflective layer 26a and the second reflective layer 26b are installed to interpose the quantum well layer 22 and the group velocity dispersion layers 24a and 24b in the stacking direction of the quantum well layer 22 and the group velocity dispersion layers 24a and 24b. The first reflective layer 26a is provided on the supporting substrate 50. The second reflective layer 26b is provided on the second group velocity dispersion layer 24b in an area in which the incident portion 21a and an emitting portion 21b of the pulse compressing portion 20 are not provided.

The reflective layers 26a and 26b reflect the optical pulse incident to the pulse compressing portion 20. The optical pulse is incident to the pulse compressing portion 20 in a direction oblique to the stacking direction of the quantum well layer 22 and the group velocity dispersion layers 24a and 24b, as described above. Therefore, the optical pulse is incident to the upper surface of the first reflective layer 26a (surface that comes into contact with the first group velocity dispersion layer 24a), and the lower surface of the second reflective layer 26b (surface that comes into contact with the second group velocity dispersion layer 24b) in an oblique direction.

The quantum well layer 22 and the group velocity dispersion layers 24a and 24b are interposed between the first reflective layer 26a and the second reflective layer 26b. Therefore, the optical pulse that is incident to the pulse compressing portion 20 in the direction oblique to the stacking direction of the quantum well layer 22 and the group velocity dispersion layers 24a and 24b is reflected plural times by the first reflective layer 26a and the second reflective layer 26b and progresses in the quantum well layer 22 and the group velocity dispersion layers 24a and 24b. Here, the progress in the quantum well layer 22 and the group velocity dispersion layers 24a and 24b includes a case in which optical pulses always progress in the quantum well layer 22 and the group velocity dispersion layers 24a and 24b as illustrated in FIG. 1 and a case in which optical pulses progress by repeatedly being emitted from the quantum well layer 22 and the group velocity dispersion layers 24a and 24b to the outside (atmosphere) and then being incident from the outside to the quantum well layer 22 and the group velocity dispersion layers 24a and 24b. The number of times of the reflection of the optical pulse on the reflective layers 26a and 26b from being incident to the pulse compressing portion 20 until being emitted to the pulse compressing portion 20 is not particularly limited.

The reflective layers 26a and 26b are distribution Bragg reflection-type (DBR) mirrors in which high refractive index layers (not illustrated) and low refractive index layers (not illustrated) are alternately stacked. The high refractive index layers are, for example, GaAs layers (or Ga_{0.8}Al_{0.2}As layers). The low refractive index layer is, for example, AlAs layers (or Ga_{0.2}Al_{0.8}As layers). In addition, the reflective layers 26a and 26b are not limited to the DBR mirrors as long as the reflective layers 26a and 26b can reflect the optical pulse which is incident to the pulse compressing portion 20. For example, the reflective layers 26a and 26b may be metal mirrors.

The first antireflection film 30 is provided in the incident portion 21a to which the optical pulse of the pulse compressing portion 20 is incident. In the example illustrated in the drawings, the incident portion 21a of the pulse compressing portion 20 is an upper surface of the second group velocity dispersion layer 24b, and is provided in an area in which the incident portion 21a is not overlapped with the second reflective layer 26b in plain view (when viewed in the stacking direction of the quantum well layer 22 and the group velocity dispersion layers 24a and 24b). The first antireflection film 30 is, for example, a SiO₂ layer, a Ta₂O₅ layer, an Al₂O₃ layer, a TiN layer, a TiO₂ layer, a SiON layer, or a SiN layer, or a multilayer film thereof. The first antireflection film 30 can decrease the reflectivity of the optical pulse in the incident portion 21a.

The second antireflection film 32 is provided in the emitting portion 21b in which the optical pulse of the pulse compressing portion 20 is emitted. In the example illustrated in the drawings, the emitting portion 21b of the pulse compressing portion 20 is the upper surface of the second group velocity dispersion layer 24b, and is provided in a portion of the area in which the emitting portion 21b is not overlapped with the second reflective layer 26b in plain view. In the example illustrated in the drawings, the second reflective layer 26b is positioned between the emitting portion 21b and the incident portion 21a in plain view. The second antireflection film 32 is, for example, a SiO₂ layer, a Ta₂O₅ layer, an Al₂O₃ layer, a TiN layer, a TiO₂ layer, a SiON layer, or a SiN layer, or a multilayer film thereof. The second antireflection film 32 can reduce the reflectivity of the optical pulse in the emitting portion 21b.

The collimating lens 40 is provided between the optical pulse generating portion 10 and the pulse compressing portion 20. An optical pulse generated in the optical pulse generating portion 10 is incident to the collimating lens 40. The collimating lens 40 can convert the optical pulse that is incident to the pulse compressing portion 20 to parallel light.

The supporting substrate 50 supports the pulse compressing portion 20. The supporting substrate 50 is, for example, a GaAs substrate. In the short optical pulse generating apparatus 100, the pulse compressing portion 20 is formed on the supporting substrate 50 by sequentially stacking the first reflective layer 26a, the first group velocity dispersion layer 24a, the quantum well layer 22, the second group velocity dispersion layer 24b, and the second reflective layer 26b.

Subsequently, a method of manufacturing the pulse compressing portion 20 is described.

First, epitaxial growth is performed on the supporting substrate 50 in a sequence of the first reflective layer 26a, the first group velocity dispersion layer 24a, the quantum well layer 22, the second group velocity dispersion layer 24b, and the second reflective layer 26b. As the method of performing the epitaxial growth, a metal organic chemical vapor deposition (MOCVD) method, a molecular beam epitaxy (MBE) method, and the like can be used.

Subsequently, the second reflective layer 26b is patterned, a portion of the second group velocity dispersion layer 24b is exposed, and the incident portion 21a and the emitting portion 21b are provided. Subsequently, the first antireflection film 30 is formed in the incident portion 21a and the second antireflection film 32 is formed in the emitting portion 21b.

By the processes above, the pulse compressing portion 20 can be manufactured.

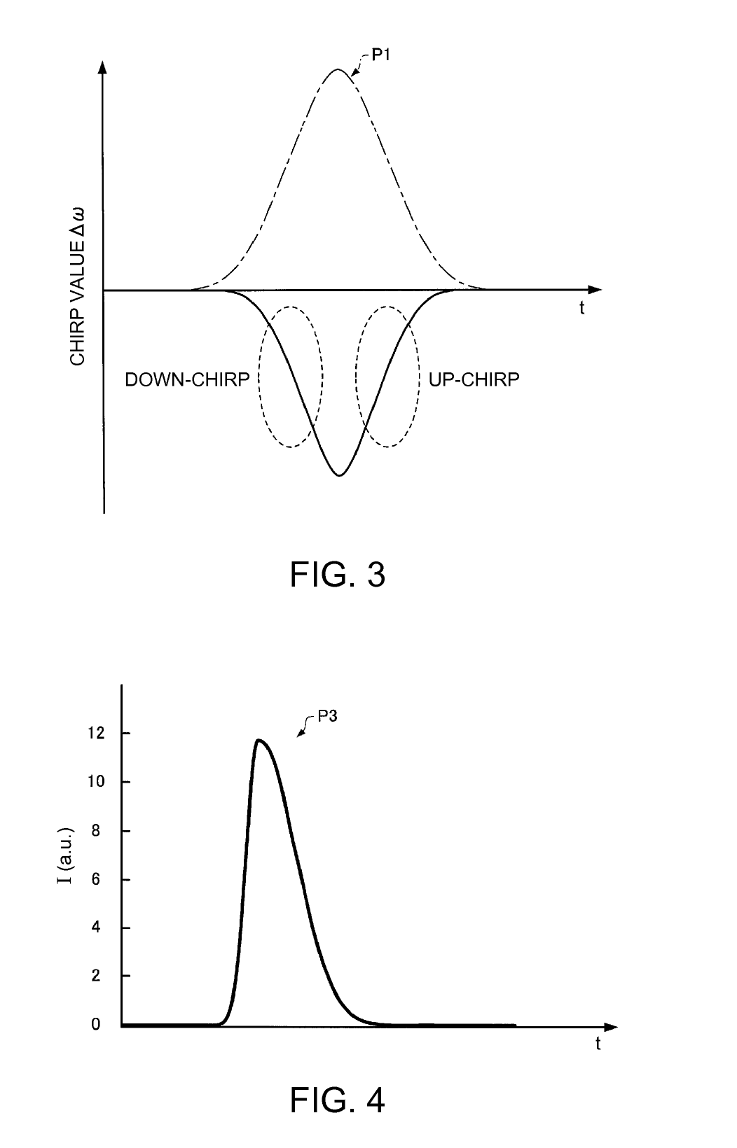

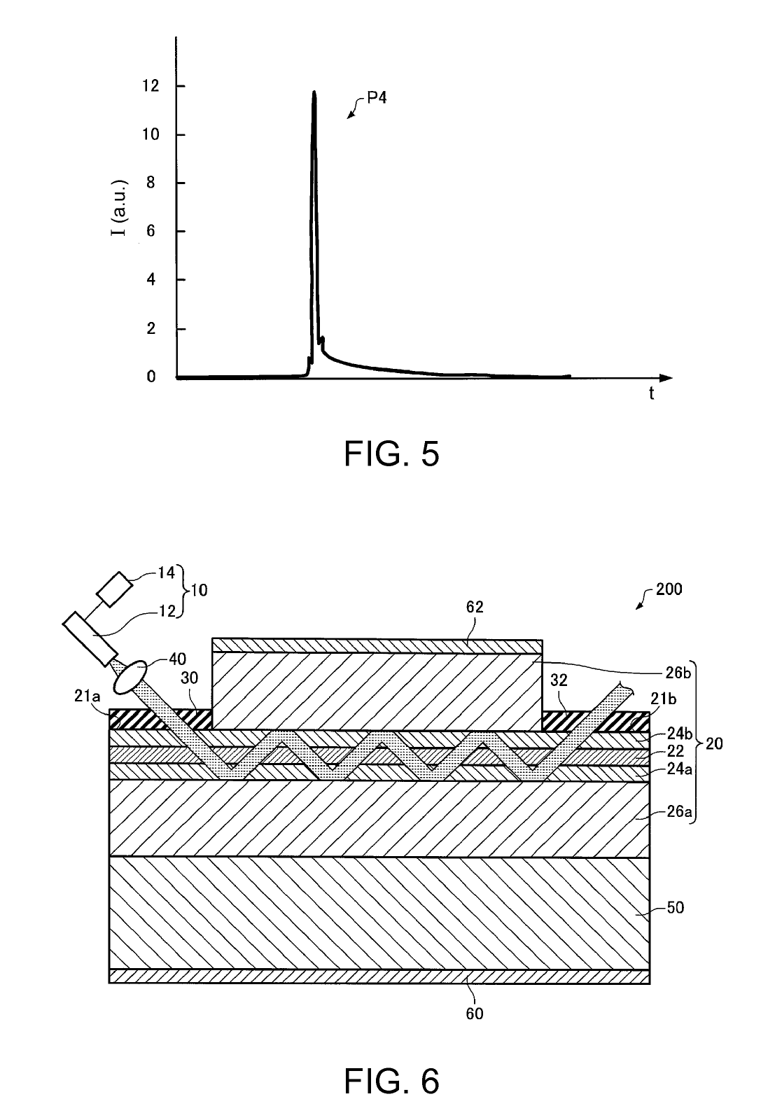

Subsequently, an operation of the short optical pulse generating apparatus 100 is described. FIG. 2 is a graph illustrating an example of an optical pulse P1 generated in the optical pulse generating portion 10. FIG. 3 is a graph illustrating an example of a chirp characteristic of the quantum well layer 22. FIG. 4 is a graph illustrating an example of an optical pulse P3 generated in the pulse compressing portion 20. FIG. 5 is a graph illustrating an example of an optical pulse P4 generated in the pulse compressing portion 20.

In addition, the optical pulse P3 illustrated in FIG. 4 is an optical pulse after the optical pulse P1 passes through the second group velocity dispersion layer 24b, the quantum well layer 22, and the first group velocity dispersion layer 24a, and is reflected on the first reflective layer 26a, and before the optical pulse P1 is incident to the quantum well layer 22 again. In addition, the optical pulse P4 illustrated in FIG. 5 is an optical pulse after the optical pulse P3 passes through the quantum well layer 22 and the group velocity dispersion layers 24a and 24b while being reflected on the reflective layers 26a and 26b plural times, and before being emitted from the pulse compressing portion 20 (a state of being emitted from the short optical pulse generating apparatus 100).

In addition, a horizontal axis t in the graph illustrated in FIG. 2 indicates time, and a vertical axis I indicates light intensity (in proportion to the square of electric field amplitude). A horizontal axis t in the graph illustrated in FIG. 3 indicates time, and a vertical axis AG) indicates a chirp quantity (variation of frequency). In FIG. 3, the optical pulse P1 is indicated by an alternate long and short dashed line, and the chirp quantity AG) corresponding to the optical pulse P1 is indicated by a solid line. The horizontal axes t of the graphs illustrated in FIGS. 4 and 5 indicate time, and the vertical axes I indicate light intensities. The graphs illustrated in FIGS. 4 and 5 correspond to the graph illustrated in FIG. 2.

The optical pulse P1 generated in the optical pulse generating portion 10 is as illustrated in FIG. 2 is, for example, a Gauss waveform. In the example illustrated in the drawings, a pulse width (full width at half maximum FWHM) t of the optical pulse P1 is 10 ps. The optical pulse P1 generated in the optical pulse generating portion 10 is incident to the pulse compressing portion 20 via the collimating lens 40.

The optical pulse P1 that is incident to the pulse compressing portion 20 passes through the second group velocity dispersion layer 24b, and is incident to the quantum well layer 22.

The quantum well layer 22 has a chirp characteristic in proportion to the light intensity. Equation 1 below is an equation illustrating an effect of the frequency chirp.

$$Δω = - \frac{{n}_{2} l {ω}_{0}}{2 c {τ}_{r}} {\vert E \vert}^{2} \qquad ( 1 )$$

Here, Δω represents a chirp quantity (variation of frequency), c represents a speed of light, τᵣ represents response time of a non-linear refractive index effect, n₂ represents response time of a non-linear refractive index, l represents a migration distance when the optical pulse passes through the quantum well layer 22, ω₀ represents an initial frequency, and E represents an amplitude of the electric field.

The quantum well layer 22 applies a frequency chirp presented in Equation 1 to the optical pulse P1 that passes through the quantum well layer 22. Specifically, as illustrated in FIG. 3, with respect to the optical pulse P1, the quantum well layer 22 causes the frequency to decrease with time in the front portion of the optical pulse P1, and causes the frequency to increase with time in the rear portion of the optical pulse P1. That is, the quantum well layer 22 causes the front portion of the optical pulse P1 to be down-chirped, and causes the rear portion of the optical pulse P1 to be up-chirped. Accordingly, if the optical pulse P1 passes through the quantum well layer 22, the optical pulse P1 becomes an optical pulse (hereinafter, referred to as “optical pulse P2”) of which the front portion is down-chirped and the rear portion is up-chirped. The chirped optical pulse P2 (not illustrated) passes through the quantum well layer 22 and is incident to the first group velocity dispersion layer 24a.

The first group velocity dispersion layer 24a generates the group velocity difference corresponding to the wavelength (frequency) in the chirped optical pulse P2 (group velocity dispersion), and performs pulse compression. Specifically, the first group velocity dispersion layer 24a generates the positive group velocity dispersion in the optical pulse P2 while the optical pulse P2 passes through the first group velocity dispersion layer 24a (while the optical pulse P2 is incident to the first group velocity dispersion layer 24a, is reflected on the first reflective layer 26a, and is incident to the quantum well layer 22 again). Accordingly, the front portion of the down-chirped optical pulse P2 is compressed, and the optical pulse P3 illustrated in FIG. 4 is generated. The pulse width of the optical pulse P3 is smaller than the pulse width of the optical pulse P1. The optical pulse P3 is incident to the quantum well layer 22 again.

The optical pulse P3 that is incident to the quantum well layer 22 is subjected to the pulse compression while the frequency in the quantum well layer 22 is chirped and the optical pulse P3 passes through the second group velocity dispersion layer 24b (while the optical pulse P3 is incident to the second group velocity dispersion layer 24b, is reflected on the second reflective layer 26b, and is incident to the quantum well layer 22 again).

The optical pulse passes through the quantum well layer 22 and the group velocity dispersion layers 24a and 24b while being multi-reflected between the reflective layers 26a and 26b. That is, with respect to the optical pulse, the application of the frequency chirp and the pulse compression are repeated in the short optical pulse generating apparatus 100. The pulse width of the optical pulse decreases while the application of the frequency chirp and the pulse compression are repeated. That is, as the number of the times of the reflection between the reflective layers 26a and 26b becomes greater, the chirp quantity applied to the optical pulse becomes greater and the greater group velocity difference in the optical pulse is generated. Also, as illustrated in FIG. 5, the short optical pulse generating apparatus 100 emits the optical pulse P4 which is multireflected so that the pulse width becomes small. In the example illustrated in the drawings, the pulse width t of the optical pulse P4 is 0.33 ps.

The short optical pulse generating apparatus 100 has, for example, the following characteristics.

In the short optical pulse generating apparatus 100, the pulse compressing portion 20 has the quantum well layer 22. The quantum well layer 22 causes the frequency of the optical pulse to be chirped. Accordingly, in the short optical pulse generating apparatus 100, the chirp quantity of the optical pulse can be caused to be greater than, for example, the embodiment in which the quantum well layer 22 is not provided so that the pulse width can be sufficiently compressed in the group velocity dispersion layers 24a and 24b. Accordingly, the short optical pulse generating apparatus 100 can cause the optical pulse having a small pulse width to be generated.

In the short optical pulse generating apparatus 100, the pulse compressing portion 20 includes the group velocity dispersion layers 24a and 24b that are stacked with the quantum well layer 22 interposed therebetween and is formed of a group velocity dispersion medium and the reflective layers 26a and 26b that interpose the quantum well layer 22 and the group velocity dispersion layers 24a and 24b in the stacking direction of the quantum well layer 22 and the group velocity dispersion layers 24a and 24b. Therefore, the optical pulse that is incident to the pulse compressing portion 20 is reflected on the reflective layers 26a and 26b plural times and progresses in the quantum well layer 22 and the group velocity dispersion layers 24a and 24b. Accordingly, in the pulse compressing portion 20, with respect to the optical pulse, the application of the frequency chirp and the pulse compression can be performed, and the chirp quantity of the optical pulse and the group velocity dispersion value of the group velocity dispersion layers 24a and 24b can be caused to become great. Accordingly, the short optical pulse generating apparatus 100 can generate the optical pulse having a smaller pulse width.

In addition, since the short optical pulse generating apparatus 100 includes the group velocity dispersion layers 24a and 24b, the short optical pulse generating apparatus 100 can control the group velocity dispersion values of the group velocity dispersion layers 24a and 24b in the pulse compressing portion 20, for example, by controlling the film thickness of the group velocity dispersion layers 24a and 24b. Accordingly, the short optical pulse generating apparatus 100 can balance between the chirp quantity of the optical pulse and the group velocity dispersion value of the group velocity dispersion layers 24a and 24b in the pulse compressing portion 20 by controlling the film thickness of the group velocity dispersion layers 24a and 24b.

In the short optical pulse generating apparatus 100, the group velocity dispersion layers 24a and 24b are semiconductor layers. Therefore, the quantum well layer 22 and the group velocity dispersion layers 24a and 24b can be formed by epitaxial growth. Accordingly, in the short optical pulse generating apparatus 100, the pulse compressing portion 20 can be easily manufactured.

In the short optical pulse generating apparatus 100, the reflective layers 26a and 26b are distribution Bragg reflection-type mirrors. The distribution Bragg reflection-type mirrors can be formed by alternately stacking high refractive index layers (for example, GaAs layers) and low refractive index layers (for example, AlAs layers). Therefore, in the short optical pulse generating apparatus 100, the pulse compressing portion 20 can be easily manufactured.

In the short optical pulse generating apparatus 100, the pulse compressing portion 20 can be easily manufactured since the quantum well layer 22, the group velocity dispersion layers 24a and 24b, and the reflective layers 26a and 26b can be formed by epitaxial growth on the supporting substrate 50.

In the short optical pulse generating apparatus 100, the optical pulse is incident to the pulse compressing portion 20 in the direction oblique to the stacking direction of the quantum well layer 22 and the group velocity dispersion layers 24a and 24b. Therefore, in the pulse compressing portion 20, the optical pulse can be emitted by reflecting the optical pulse between the reflective layers 26a and 26b plural times. Accordingly, in the pulse compressing portion 20, with respect to the optical pulse, the application of the frequency chirp and the pulse compression can be repeated so that the optical pulse having a small pulse width can be generated.

In the short optical pulse generating apparatus 100, the first antireflection film 30 is provided in the incident portion 21a to which the optical pulse of the pulse compressing portion 20 is incident. Accordingly, the reflectivity of the optical pulse in the incident portion 21a can be decreased.

The short optical pulse generating apparatus 100 includes the collimating lens 40 that converts the optical pulse incident to the pulse compressing portion 20 to parallel light. Therefore, in the short optical pulse generating apparatus 100, the diffusion of the optical pulse that is incident to the pulse compressing portion 20 can be suppressed.

### 2. Modification Example of Short Optical Pulse Generating Apparatus

### 2.1. First Modification Example

Subsequently, the short optical pulse generating apparatus according to a first modification example of the embodiment will be described with reference to the drawings. FIG. 6 is a diagram schematically illustrating a short optical pulse generating apparatus 200 according to the first modification example of the embodiment. Hereinafter, with respect to the short optical pulse generating apparatus 200 according to the first modification example of the embodiment, members that have the same functions as the components of the short optical pulse generating apparatus 100 according to the embodiment are denoted by the same reference numerals, and the detailed descriptions thereof are omitted.

The short optical pulse generating apparatus 200 is different from the short optical pulse generating apparatus 100 described above in that the short optical pulse generating apparatus 200 contains electrodes (a first electrode 60 and a second electrode 62) that apply a reverse bias to the pulse compressing portion 20 as illustrated in FIG. 6. Specifically, the first electrode 60 and the second electrode 62 are electrodes for applying a reverse bias to the quantum well layer 22 and the group velocity dispersion layers 24a and 24b.

The first electrode 60 is provided on the lower surface of the supporting substrate 50. As the first electrode 60, for example, an electrode obtained by stacking a Cr layer, an AuGe layer, a Ni layer, and an Au layer is used. The second electrode 62 is provided on the second reflective layer 26b. As the second electrode 62, for example, an electrode obtained by stacking a Cr layer, an AuZn layer, and an Au layer is used. In addition, a contact layer (not illustrated) may be provided between the second reflective layer 26b and the second electrode 62. The contact layer is, for example, a p-type GaAs layer.

In the short optical pulse generating apparatus 200, the supporting substrate 50 is, for example, an n-type GaAs substrate. The first reflective layer 26a is an n-type DBR. The first group velocity dispersion layer 24a is an n-type AlGaAs layer. The quantum well layer 22 is an i-type AlGaAs layer. The second group velocity dispersion layer 24b is a p-type AlGaAs layer. The second reflective layer 26b is a p-type DBR.

As described above, the short optical pulse generating apparatus 200 includes the electrodes 60 and 62 that apply a reverse bias to the pulse compressing portion 20. Therefore, in the short optical pulse generating apparatus 200, an absorption characteristic of the quantum well layer 22 can be controlled, and the frequency chirp quantity of the optical pulse can be adjusted. Further, in the short optical pulse generating apparatus 200, the group velocity dispersion values of the group velocity dispersion layers 24a and 24b can be controlled by the electrodes 60 and 62.

### 2.2. Second Modification Example

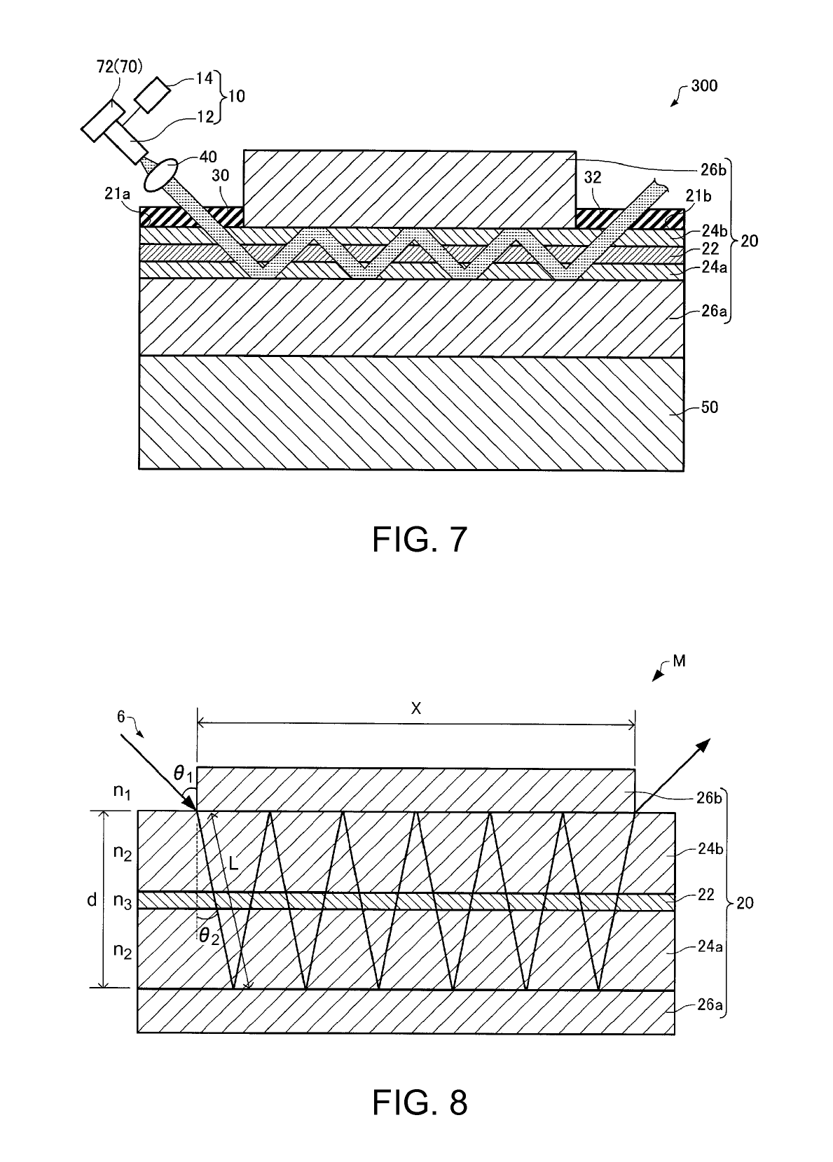

Subsequently, a short optical pulse generating apparatus according to the second modification example of the embodiment will be described with reference to the drawings. FIG. 7 is a diagram schematically illustrating a short optical pulse generating apparatus 300 according to the second modification example of the embodiment. In the short optical pulse generating apparatus 300 according to the second modification example of the embodiment, members that have the same functions as the components of the short optical pulse generating apparatus 100 according to the embodiment are denoted by the same reference numerals, and the detailed descriptions thereof are omitted.

As illustrated in FIG. 7, the short optical pulse generating apparatus 300 is different from the short optical pulse generating apparatus 100 described above in that an incident angle variable mechanism 70 that changes the incident angle of the optical pulse with respect to the pulse compressing portion 20 is included.

The incident angle variable mechanism 70 includes, for example, a stage 72 on which the light emitting element 12 is mounted and a drive circuit (not illustrated) that drives (rotates) the stage 72. The stage 72 can rotate based on a signal from the drive circuit. If the stage 72 rotates, the light emitting element 12 can be rotated so that an incident angle of the optical pulse to the pulse compressing portion 20, that is, the incident angle to the reflective layers 26a and 26b can be changed.

In addition, the incident angle variable mechanism 70 is not limited to the form of rotating the light emitting element 12, and may be a form in which the incident angle of the optical pulse to the pulse compressing portion 20 is changed by rotating the pulse compressing portion 20 (the reflective layers 26a and 26b). In addition, the incident angle variable mechanism 70 may be a form in which the incident angle of the optical pulse to the pulse compressing portion 20 is changed by rotating an optical device such as a mirror (not illustrated) that changes the progress direction of the optical pulse incident to the pulse compressing portion 20.

The short optical pulse generating apparatus 300 includes the incident angle variable mechanism 70 that changes the incident angle of the optical pulse to the pulse compressing portion 20 as described above. Accordingly, in the short optical pulse generating apparatus 300, the number of times of the reflection of the optical pulse on the reflective layers 26a and 26b can be changed. Accordingly, in the short optical pulse generating apparatus 300, the chirp quantity of the optical pulse and the group velocity dispersion value of the group velocity dispersion layers 24a and 24b can be changed, and the pulse width of the optical pulse generated in the short optical pulse generating apparatus 300 can be changed.

In addition, though not illustrated, the short optical pulse generating apparatus 300 may include the electrodes 60 and 62 that apply a reverse bias to the pulse compressing portion 20 in the same manner as in the short optical pulse generating apparatus 200 illustrated in FIG. 6 as described above.

Hereinafter, the incident angle of optical pulse to the pulse compressing portion 20 and a relationship between the chirp quantity and the group velocity dispersion value are described. FIG. 8 is a diagram schematically illustrating a model M for describing an incident angle of the optical pulse to the pulse compressing portion 20 and a relationship between the chirp quantity and the group velocity dispersion value.

In the model M, as illustrated in FIG. 8, an incident angle of the optical pulse generated in the optical pulse generating portion 10 that is incident to the pulse compressing portion 20 is set to be θ₁. A refractive angle of the optical pulse of the pulse compressing portion 20 (the second group velocity dispersion layer 24b) is set to be θ₂. A refractive index of a medium (for example, the air) before the optical pulse is incident to the pulse compressing portion 20 is set to be n₁. The refractive index of the group velocity dispersion layers 24a and 24b is set to be n₂. A refractive index of the quantum well layer 22 is set to be n₃. A length of the pulse compressing portion 20 is set to be X. The thickness of the group velocity dispersion layers 24a and 24b (the sum of the thickness of the first group velocity dispersion layer 24a and the thickness of the second group velocity dispersion layer 24b) is set to be d. In addition, the thickness of the quantum well layer 22 is negligible compared with the thickness of the group velocity dispersion layers 24a and 24b, and the thickness d of the group velocity dispersion layers 24a and 24b is the same as the distance between the reflective layers 26a and 26b. When the optical pulse progresses in the quantum well layer 22 and the group velocity dispersion layers 24a and 24b while being reflected between two reflective layers 26a and 26b, the migration distance when the optical pulse progresses from the second reflective layer 26b to the first reflective layer 26a is set to be L.

First, the group velocity dispersion value that is obtainable in the model M is calculated.

Equation 2 below is satisfied by Snell's law.

n₁ sin θ₁=n₂ sin θ₂ (2)

Here, the thickness of the quantum well layer 22 is set to be negligible compared with the thickness of the group velocity dispersion layers 24a and 24b, and n₃≅n₂ is satisfied. At this point, if Equation 2 is used, the distance L is expressed as Equation 3 below.

$$L = \frac{d}{cos {θ}_{2}} = \frac{d}{\sqrt{1 - {sin}^{2} {θ}_{2}}} = \frac{d}{\sqrt{1 - {( \frac{{n}_{1}}{{n}_{2}} )}^{2} {sin}^{2} {θ}_{1}}} \qquad ( 3 )$$

If a group velocity dispersion value for each unit length of the group velocity dispersion layers 24a and 24b is set to be p, a desired group velocity dispersion value is set to be q, and a necessary distance for obtaining the desired group velocity dispersion value q becomes q/p. Accordingly, a required number of times of the reflection RT_{g} is expressed by Equation 4 below.

$${RT}_{g} = \frac{q / p}{L} - 1 = \frac{q}{p} \frac{\sqrt{1 - {( \frac{{n}_{1}}{{n}_{2}} )}^{2} {sin}^{2} {θ}_{1}}}{d} - 1 \qquad ( 4 )$$

The length X of the pulse compressing portion 20 at this point is expressed by Equation 5 below.

$$X = ( {RT}_{g} + 1 ) d tan {θ}_{2} = \frac{q}{p} \frac{{n}_{1}}{{n}_{2}} sin {θ}_{1} \qquad ( 5 )$$

If Equation 5 is changed, the group velocity dispersion value q obtained in the pulse compressing portion 20 is expressed by Equation 6 below.

$$q = \frac{{n}_{2}}{{n}_{1}} \frac{pX}{sin {θ}_{1}} \qquad ( 6 )$$

As illustrated in Equation 6, the thickness d of the group velocity dispersion layers 24a and 24b can be set to be a parameter that does not influence the group velocity dispersion value q. Accordingly, if the reflection loss in the pulse compressing portion 20 is negligible, the thickness d of the group velocity dispersion layers 24a and 24b can be caused to be small so that the short optical pulse generating apparatus can be minimized. If the reflection loss is not negligible, the thickness d of the group velocity dispersion layers 24a and 24b is caused to be great so that the number of times of the reflection between the reflective layers 26a and 26b can be reduced.

Here, the wavelength of the optical pulse generated in the optical pulse generating portion 10 is set to be 850 nm, the incident angle θ₁ is set to be 0.1°, a medium before the optical pulse is incident to the pulse compressing portion 20 is the air (n₁=1), the material of the group velocity dispersion layers 24a and 24b is a AlGaAs layer (Al_{0.3}Ga_{0.7}As), and the thickness d of the group velocity dispersion layers 24a and 24b is set to be 4 μm. The refractive index n₂ of the group velocity dispersion layers 24a and 24b is 3.38 with respect to the light having a wavelength of 850 nm. The group velocity dispersion value p for 1 mm of the group velocity dispersion layers 24a and 24b becomes 3.2×10⁻²⁷ s²/mm with respect to the light having the wavelength of 850 nm. If the desired group velocity dispersion value q is 1×10⁻²⁴ s², the number of times of the reflection RT_{g}≅78124 is satisfied by Equation 4. In addition, from Equation 5, the length X of the pulse compressing portion 20≅161 μm is satisfied.

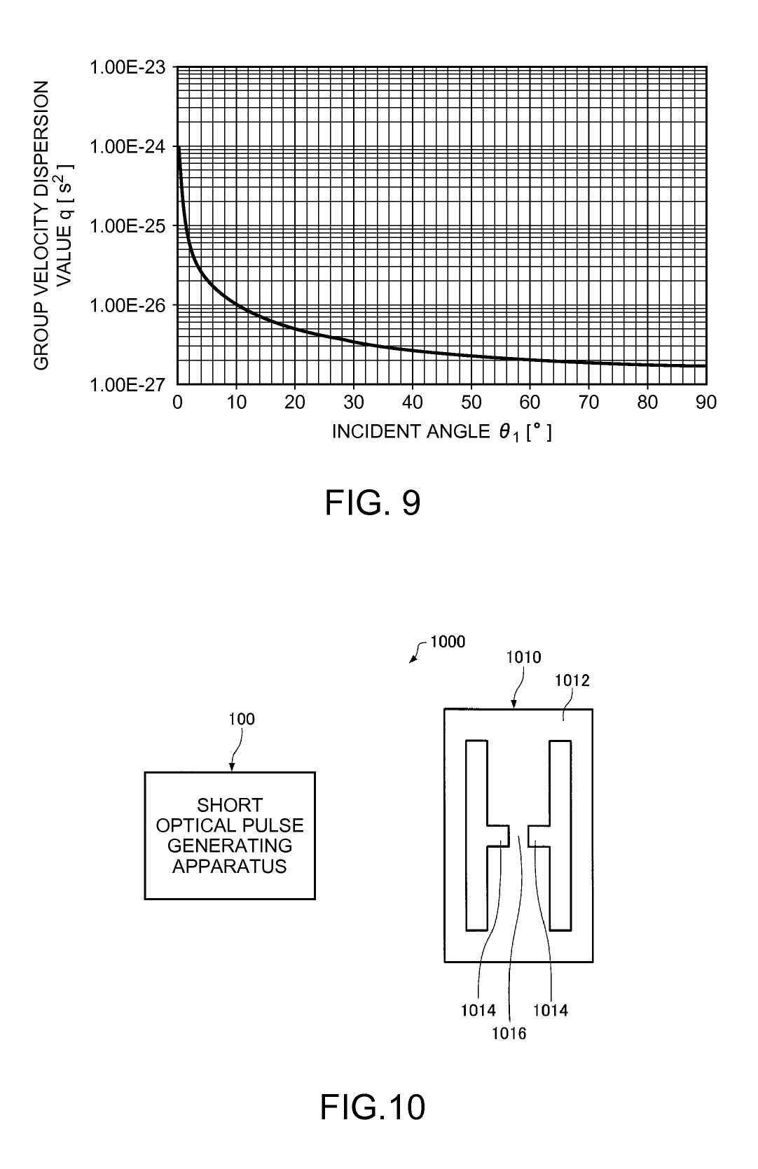

As described above, if the length X of the pulse compressing portion 20 is set to be 161 μm, n₁ is set to be 1, n₂ is set to be 3.38, and p is set to be 3.2 c 10⁻²⁷ s²/mm, the incident angle θ₁ can be changed, and the relationship between the incident angle θ₁ and the group velocity dispersion value q is as illustrated in FIG. 9, from Equation 6. From FIG. 9, it is possible to understand that the group velocity dispersion value can be changed in the range of 1.75×10⁻²⁷ s² to 1×10⁻²⁴ s² by changing the incident angle θ₁.

Subsequently, the chirp quantity that is applied whenever the optical pulse passes through the quantum well layer 22 in the pulse compressing portion 20 once is set to be r. If the number of times of the reflection RT_{g} described above is used, the chirp quantity s obtained while the pulse compressing portion 20 is propagated is expressed as below.

s=r(RT_{g}+1) (7)

If Equation 4 above is used, r is expressed by Equation 8 below.

$$\frac{s}{r} = \frac{q}{p} \frac{\sqrt{1 - {( \frac{{n}_{1}}{{n}_{2}} )}^{2} {sin}^{2} {θ}_{1}}}{d} \\ r = \frac{s}{\frac{q}{p} \frac{\sqrt{1 - {( \frac{{n}_{1}}{{n}_{2}} )}^{2} {sin}^{2} {θ}_{1}}}{d}} \qquad ( 8 )$$

The chirp quantity r is adjusted to satisfy Equation 8 above. As a method of adjusting the chirp quantity r, for example, a method of adjusting the number of wells in the quantum well layer 22, a method of adjusting a bias to be applied to the pulse compressing portion 20 by the electrodes 60 and 62, and a method of adjusting the number of times of the reflection of the optical pulse on the reflective layers 26a and 26b are included.

### 3. Terahertz Wave Generating Apparatus

Subsequently, the terahertz wave generating apparatus 1000 according the embodiment will be described with reference to the drawings. FIG. 10 is a diagram illustrating a configuration of the terahertz wave generating apparatus 1000 according to the embodiment.

As illustrated in FIG. 10, a terahertz wave generating apparatus 1000 includes the short optical pulse generating apparatus according to the invention and a photoconductive antenna 1010. Here, as the short optical pulse generating apparatus according to the embodiment, a case in which the short optical pulse generating apparatus 100 is used is described.

The short optical pulse generating apparatus 100 generates a short optical pulse (for example, the optical pulse P4 illustrated in FIG. 5) which is excited light. The pulse width of the short optical pulse generated by the short optical pulse generating apparatus 100 is, for example, in the range of 1 fs to 800 fs.

The photoconductive antenna 1010 generates the terahertz wave by applying the short optical pulse generated in the short optical pulse generating apparatus 100. In addition, the terahertz wave refers to an electromagnetic wave of which the frequency is in the range of 100 GHz to 30 THz, and an electromagnetic wave of which the frequency is particularly in the range of 300 GHz to 3 THz.

In the example illustrated in the drawings, the photoconductive antenna 1010 is a dipole-shaped photoconductive antenna (PCA). The photoconductive antenna 1010 includes a substrate 1012 which is a semiconductor substrate, and a pair of electrodes 1014 provided on the substrate 1012 and arranged to face each other via a gap 1016. If the optical pulse is applied to a portion between the electrodes 1014, the photoconductive antenna 1010 generates a terahertz wave.

The substrate 1012 includes, for example, a semi-insulating GaAs (SI-GaAs) substrate and a semiconductor low-temperature growth GaAs (LT-GaAs) layer provided on the SI-GaAs substrate. The material of the electrodes 1014 is, for example, Au. The distance between the pair of electrodes 1014 is not particularly limited, and appropriately set according to the condition. The distance between the pair of electrodes 1014 is, for example, in the range of 1 μm to 10 μm.

First, in the terahertz wave generating apparatus 1000, the short optical pulse generating apparatus 100 causes the short optical pulse to be generated and emitted to the gap 1016 of the photoconductive antenna 1010. The short optical pulse emitted from the short optical pulse generating apparatus 100 applies the gap 1016 of the photoconductive antenna 1010. In the photoconductive antenna 1010, the free electron is excited by applying the short optical pulse to the gap 1016. Then, the free electron is accelerated by applying the voltage to a portion between the electrodes 1014. Accordingly, the terahertz wave is generated.

### 4. Imaging Apparatus

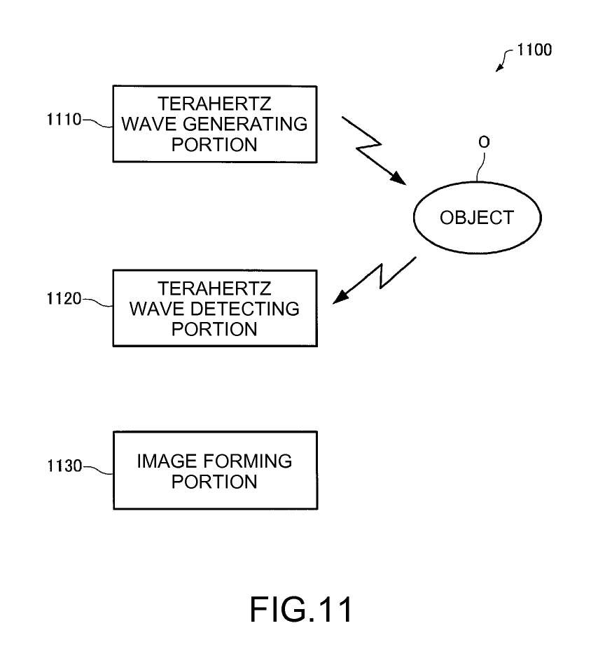

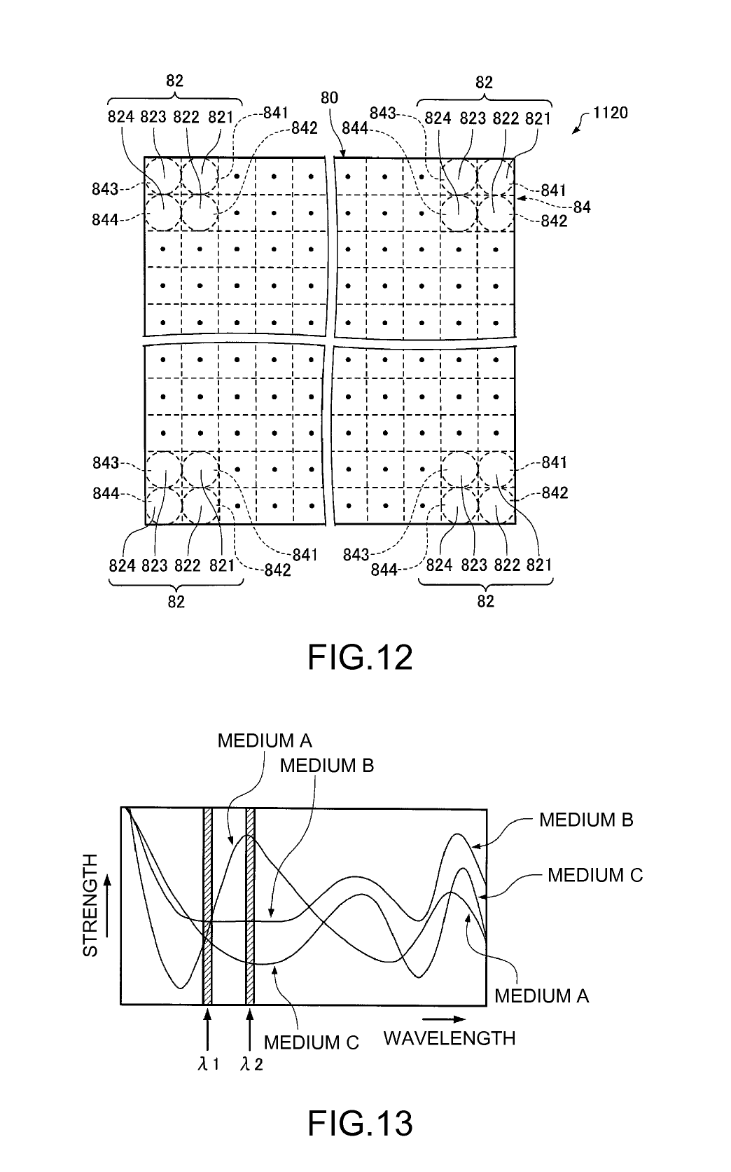

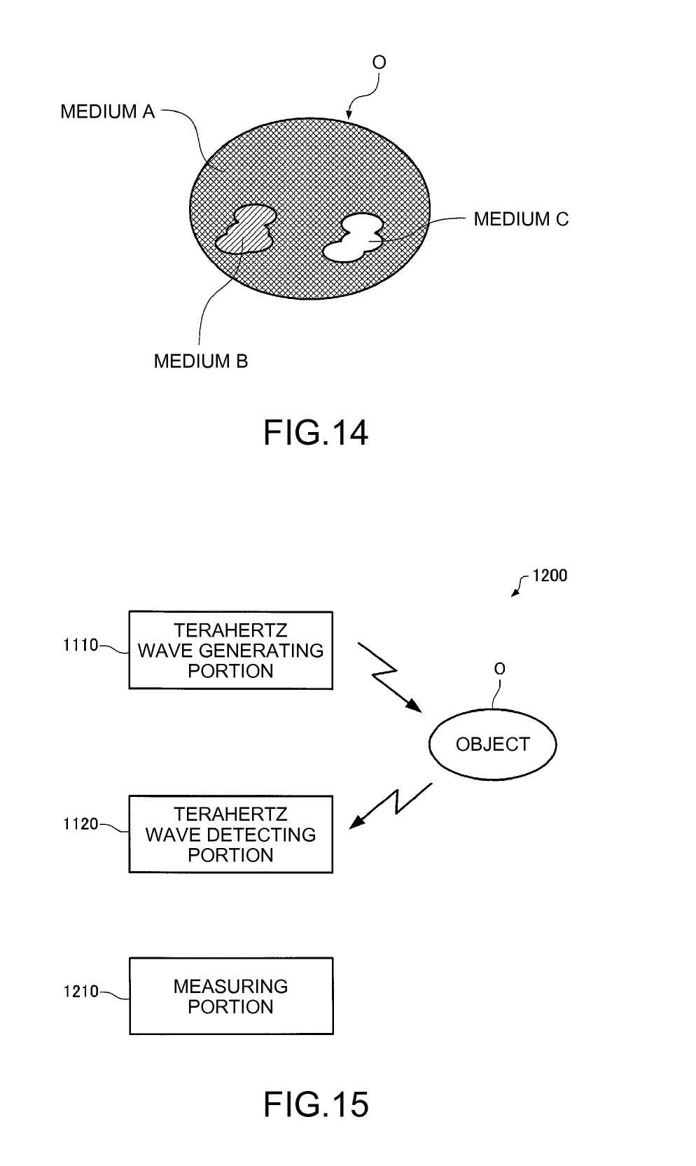

Subsequently, an imaging apparatus 1100 according to the embodiment will be described with reference to the drawings. FIG. 11 is a block diagram illustrating the imaging apparatus 1100 according to the embodiment. FIG. 12 is a plan view schematically illustrating a terahertz wave detecting portion 1120 of the imaging apparatus 1100 according to the embodiment. FIG. 13 is a graph illustrating a spectrum in the terahertz band of the object. FIG. 14 is a diagram illustrating an example showing distribution of the media A, B, and C of the object.

As illustrated in FIG. 11, the imaging apparatus 1100 includes a terahertz wave generating portion 1110 that generates a terahertz wave, the terahertz wave detecting portion 1120 that detects a terahertz wave that is emitted from the terahertz wave generating portion 1110 and permeates an object O or a terahertz wave that is reflected on the object O and an image forming portion 1130 that generates an image of the object O, that is, image data based on the detection result of the terahertz wave detecting portion 1120.

As the terahertz wave generating portion 1110, the terahertz wave generating apparatus according to the invention can be used. Here, as the terahertz wave generating apparatus according to the invention, a case in which the terahertz wave generating apparatus 1000 is used is described.

As illustrated in FIG. 12, as the terahertz wave detecting portion 1120, an apparatus including a filter 80 through which a terahertz wave of the objective wavelength passes and a detecting portion 84 that detects the terahertz wave of the objective wavelength that has passed through the filter 80 is used. In addition, as the detecting portion 84, an apparatus that converts the terahertz wave to heat detects the terahertz wave, that is, an apparatus that can convert the terahertz wave to heat and can detect the energy (strength) of the terahertz wave is used. As the detecting portion, for example, a pyroelectric sensor, and a bolometer are included. In addition, the configuration of the terahertz wave detecting portion 1120 is not limited to the configuration described above.

In addition, the filter 80 includes plural pixels (unit filter portions) 82 which are two-dimensionally arranged. That is, the pixels 82 are arranged in a matrix shape.

In addition, the pixels 82 include plural areas through which terahertz waves of wavelengths which are different from each other pass, that is, plural areas through which wavelengths of terahertz waves pass (hereinafter, referred to as “pass wavelength”) are different from each other. In addition, in the configuration illustrated in the drawings, the pixels 82 each include a first area 821, a second area 822, a third area 823, and a fourth area 824.

In addition, the detecting portion 84 includes first unit detecting portions 841, second unit detecting portions 842, third unit detecting portions 843, and fourth unit detecting portions 844 respectively provided corresponding to the first areas 821, the second areas 822, the third areas 823, and the fourth areas 824 of the pixels 82 of the filter 80. The first unit detecting portions 841, the second unit detecting portions 842, the third unit detecting portions 843, and the fourth unit detecting portions 844 convert the terahertz waves to heat passing through the first areas 821, the second areas 822, the third areas 823, and the fourth areas 824 of the pixels 82, respectively. Accordingly, the respective pixels 82 can securely detect the four objective terahertz waves of the wavelengths, respectively.

Subsequently, a usage example of the imaging apparatus 1100 is described.

First, the object O that becomes a target of stereoscopic imaging is formed of three media A, B, and C. The imaging apparatus 1100 performs stereoscopic imaging of the object O. In addition, the terahertz wave detecting portions 1120 detect, for example, the terahertz wave reflected on the object O.

In addition, in the pixels 82 of the filter 80 of the terahertz wave detecting portions 1120, the first areas 821 and the second areas 822 are used. When the pass wavelengths of the first areas 821 are set to be λ1 and the pass wavelengths of the second areas 822 are set to be λ2, the pass wavelengths λ1 of the first areas 821 and the pass wavelengths λ2 of the second areas 822 are set so that if the strength of the configuration in wavelengths λ1 of the terahertz waves reflected on the object O are α1 and the strengths of the configurations in the wavelengths λ2 are α2, the differences (α2−α1) between the strengths α2 and the strengths α1 are remarkably distinctive in the media A, B, and C.

As illustrated in FIG. 13, the difference (α2−α1) between the strength α2 of the component in the wavelength λ2 and the strength α1 of the component in the wavelength λ1 of the terahertz waves reflected on the object O in the medium A becomes positive. In addition, the difference (α2−α1) between the strength α2 and the strength α1 in the medium B becomes 0. In addition, the difference (α2−α1) between the strength α2 and the strength α1 in the medium C becomes negative.

When stereoscopic imaging of the object O is performed by the imaging apparatus 1100, terahertz waves are first generated by the terahertz wave generating portion 1110, and the terahertz waves are applied to the object O. Also, the terahertz waves reflected on the object O are detected as α1 and α2 in the terahertz wave detecting portions 1120. The detection results are transmitted to the image forming portion 1130. Further, the application of the terahertz waves to the object O and the detection of the terahertz waves reflected on the object O are performed on the entire body of the object O.

In the image forming portion 1130, the differences (α2−α1) of the strengths α2 of the components in the wavelengths λ2 of the terahertz waves that pass through the second areas 822 of the filter 80 and the strengths α1 of the components in the wavelengths λ1 of the terahertz waves that pass through the first areas 821 are obtained based on the detection results. Also, in the object O, portions in which the differences become positive are determined to be the medium A, portions in which the differences become zero are determined to be the medium B, and portions in which the differences become negative are determined to be the medium C to be specified.

In addition, in the image forming portion 1130, the image data of the image showing the distribution of the media A, B, and C of the object O as illustrated in FIG. 14 is created. The image data is transmitted from the image forming portion 1130 to a monitor (not illustrated), and the distribution of the media A, B, and C of the object O is displayed on the monitor. In this case, areas are divided by colors and displayed so that, for example, an area in which the medium A of the object O is distributed becomes black, an area in which the medium B is distributed becomes gray, and an area in which the medium C is distributed becomes white. In the imaging apparatus 1100, as described above, the identification of the respective media that configure the object O and the distribution measurement of media in the respective portions can be performed at the same time.

In addition, the use of the imaging apparatus 1100 is not limited to the above, and for example, when terahertz waves are applied to a person, the terahertz waves that permeate or are reflected on the person are detected and processed in the image forming portion 1130, so that it is determined whether the person has a gun, a knife, illegal drugs, or the like.

### 5. Measuring Apparatus

Subsequently, a measuring apparatus 1200 according to the embodiment will be described with reference to the drawings. FIG. 15 is a block diagram illustrating the measuring apparatus 1200 according to the embodiment. With respect to the measuring apparatus 1200 according to the embodiment described above, members that have the same functions as the components of the imaging apparatus 1100 described above are denoted by the same reference numerals, and the detailed descriptions thereof are omitted.

As illustrated in FIG. 15, the measuring apparatus 1200 includes the terahertz wave generating portion 1110 that generates terahertz waves, the terahertz wave detecting portion 1120 that detects the terahertz waves that are emitted from the terahertz wave generating portion 1110 and permeate the object O or the terahertz waves that are reflected on the object O, and a measuring portion 1210 that measures the object O based on the detection result of the terahertz wave detecting portion 1120.

Subsequently, the usage example of the measuring apparatus 1200 is described. When the stereoscopic measurement of the object O is performed by the measuring apparatus 1200, terahertz waves are first generated by the terahertz wave generating portion 1110 and the terahertz waves thereof are applied to the object O. Also, the terahertz waves that permeate the object O or the terahertz waves that are reflected on the object O are detected by the terahertz wave detecting portion 1120. The detection result is transmitted to the measuring portion 1210. In addition, the application of the terahertz waves to the object O and the detection of the terahertz waves that permeate the object O or the terahertz waves reflected on the object O are performed on the entire body of the object O.

In the measuring portion 1210, the strengths of the terahertz waves that permeate the first areas 821, the second areas 822, the third areas 823, and the fourth areas 824 of the pixels 82 of the filter 80 are obtained from the detection results, and components of the object O and cloth thereof are analyzed.

### 6. Camera

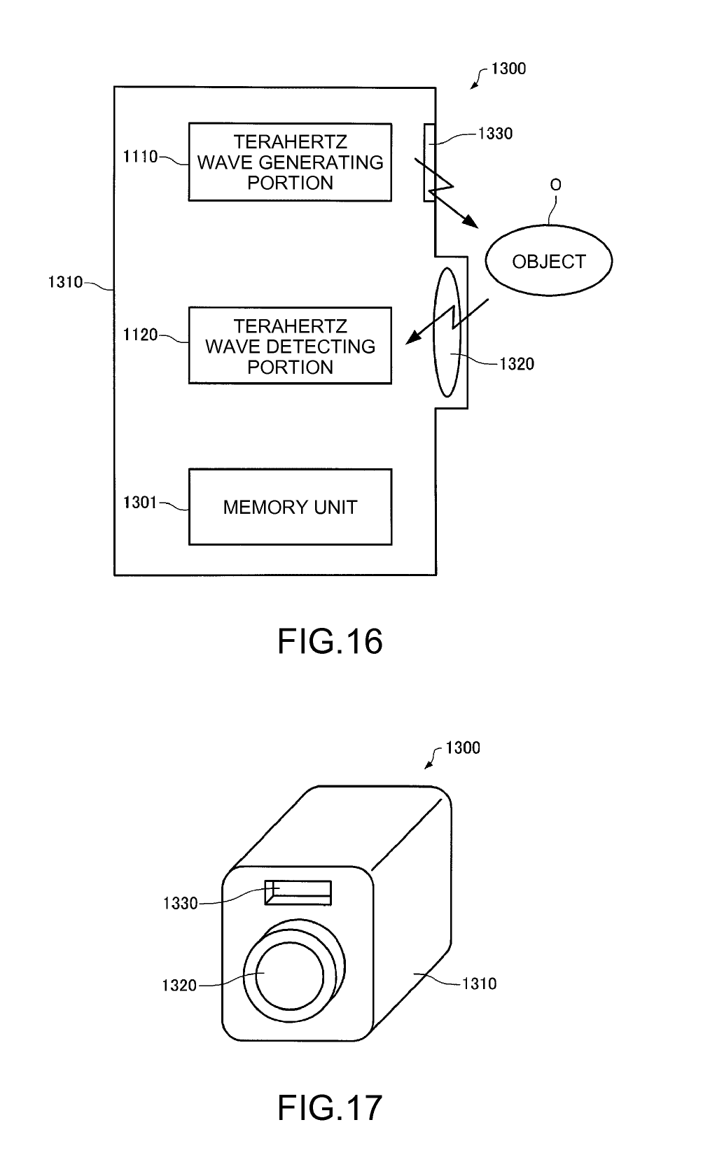

Subsequently, a camera 1300 according to the embodiment will be described with reference to the drawings. FIG. 16 is a block diagram illustrating the camera 1300 according to the embodiment. FIG. 17 is a perspective view schematically illustrating the camera 1300 according to the embodiment. With respect to the camera 1300 according to the embodiment described below, members that have the same functions as the structural members of the imaging apparatus 1100 described above are denoted by the same reference numerals, and the detailed descriptions thereof are omitted.

As illustrated in FIGS. 16 and 17, the camera 1300 includes the terahertz wave generating portion 1110 that generates terahertz waves, the terahertz wave detecting portion 1120 that detects the terahertz waves emitted from the terahertz wave generating portion 1110 and reflected on the object O and the terahertz waves that permeate the object O, and a memory unit 1301. Also, the respective portions 1110, 1120, and 1301 are stored in a housing 1310 of the camera 1300. In addition, the camera 1300 includes a lens (optical system) 1320 that focuses (images) the terahertz waves reflected on the object O in the terahertz wave detecting portion 1120, and a window portion 1330 for emitting the terahertz waves generated in the terahertz wave generating portion 1110 to the outside of the housing 1310. The lens 1320 or the window portion 1330 is formed of materials such as silicone, quartz, and polyethylene that permeate and refract the terahertz waves. In addition, the window portion 1330 may be a configuration in which an opening is simply provided, for example, a slit.

Subsequently, the usage example of the camera 1300 is described. When the object O is imaged by the camera 1300, terahertz waves are first generated by the terahertz wave generating portion 1110, and terahertz waves are applied to the object O. Also, the terahertz waves reflected on the object O are focused (imaged) in the terahertz wave detecting portions 1120 by the lens 1320 to be detected. The detection result is transmitted to and stored in the memory unit 1301. In addition, the application of the terahertz waves to the object O and the detection of the terahertz waves reflected on the object O are performed on the entire body of the object O. In addition, the detection result can be transmitted, for example, to an external device such as a personal computer. In the personal computer, respective processes can be performed based on the detection result.

The embodiments and the modification examples are provided as examples, and the invention is not limited thereto. For example, the respective embodiments and the modification examples can be appropriately combined.

The invention includes configurations substantially the same as the configuration described in the embodiment (for example, a configuration of which the function, the method, and the results are the same, or a configuration of which the object and the effect are the same). In addition, the invention includes a configuration in which a portion that is not essential is changed. In addition, the invention includes a configuration that achieves the same effect as the configuration described in the embodiment or a configuration that can achieve the same object. In addition, the invention includes a configuration in which a well-known technique is added to the configuration described in the embodiment.

The entire disclosure of Japanese Patent Application No. 2014-129024, filed Jun. 24, 2014 is expressly incorporated by reference herein.

What is claimed is:

1. A short optical pulse generating apparatus comprising:
an optical pulse generating portion that generates an optical pulse; and
a pulse compressing portion to which the optical pulse is incident and that decreases the pulse width of the optical pulse,
wherein the pulse compressing portion includes
a quantum well layer,
group velocity dispersion layers that are stacked to interpose the quantum well layer therebetween and are formed with a group velocity dispersion medium, and
reflective layers that are provided to interpose the quantum well layer and the group velocity dispersion layers in a stacking direction of the quantum well layer and the group velocity dispersion layers.

2. The short optical pulse generating apparatus according to claim 1,
wherein the group velocity dispersion layers are formed of a semiconductor.

3. The short optical pulse generating apparatus according to claim 1,
wherein the reflective layer is a distribution Bragg reflection-type mirror.

4. The short optical pulse generating apparatus according to claim 1,
wherein the optical pulse is incident to the pulse compressing portion in a direction oblique to the stacking direction.

5. The short optical pulse generating apparatus according to claim 1,
wherein an antireflection film is provided in an incident portion to which the optical pulse of the pulse compressing portion is incident.

6. The short optical pulse generating apparatus according to claim 1, further comprising:
an electrode that applies a reverse bias to the pulse compressing portion.

7. The short optical pulse generating apparatus according to claim 1, further comprising:
an incident angle changing mechanism that changes an incident angle of the optical pulse to the pulse compressing portion.

8. The short optical pulse generating apparatus according to claim 1, further comprising:
a collimating lens that converts the optical pulse that is incident to the pulse compressing portion to parallel light.

9. A terahertz wave generating apparatus comprising:
the short optical pulse generating apparatus according to claim 1; and
a photoconductive antenna to which the short optical pulse that is generated in a short optical pulse generating apparatus is applied and which causes terahertz waves to be generated.

10. A terahertz wave generating apparatus comprising:
the short optical pulse generating apparatus according to claim 2; and
a photoconductive antenna to which the short optical pulse that is generated in a short optical pulse generating apparatus is applied and which causes terahertz waves to be generated.

11. A terahertz wave generating apparatus comprising:
the short optical pulse generating apparatus according to claim 3; and
a photoconductive antenna to which the short optical pulse that is generated in a short optical pulse generating apparatus is applied and which causes terahertz waves to be generated.

12. A camera comprising:
the short optical pulse generating apparatus according to claim 1;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
a memory unit that stores a detection result of the terahertz wave detecting portion.

13. A camera comprising:
the short optical pulse generating apparatus according to claim 2;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
a memory unit that stores a detection result of the terahertz wave detecting portion.

14. A camera comprising:
the short optical pulse generating apparatus according to claim 3;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
a memory unit that stores a detection result of the terahertz wave detecting portion.

15. An imaging apparatus comprising:
the short optical pulse generating apparatus according to claim 1;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
an image forming portion that generates an image of the object based on a detection result of the terahertz wave detecting portion.

16. An imaging apparatus comprising:
the short optical pulse generating apparatus according to claim 2;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
an image forming portion that generates an image of the object based on a detection result of the terahertz wave detecting portion.

17. An imaging apparatus comprising:
the short optical pulse generating apparatus according to claim 3;
a photoconductive antenna to which the short optical pulse that is generated in a short optical pulse generating apparatus is applied and which causes terahertz waves to be generated;
a terahertz wave detecting portion that detects the terahertz waves that are emitted from the photoconductive antenna and permeate an object or the terahertz waves that are reflected on an object; and
an image forming portion that generates an image of the object based on a detection result of the terahertz wave detecting portion.

18. A measuring apparatus comprising:
the short optical pulse generating apparatus according to claim 1;
a photoconductive antenna to which the short optical pulse that is generated in a short optical pulse generating apparatus is which applied and causes terahertz waves to be generated;
a terahertz wave detecting portion that detects the terahertz waves that are emitted from the photoconductive antenna and permeate an object or the terahertz waves that are reflected on an object; and
a measuring portion that measures the object based on a detection result of the terahertz wave detecting portion.

19. A measuring apparatus comprising:
the short optical pulse generating apparatus according to claim 2;
a photoconductive antenna to which the short optical pulse that is generated in a short optical pulse generating apparatus is which applied and causes terahertz waves to be generated;
a terahertz wave detecting portion that detects the terahertz waves that are emitted from the photoconductive antenna and permeate an object or the terahertz waves that are reflected on an object; and
a measuring portion that measures the object based on a detection result of the terahertz wave detecting portion.

20. A measuring apparatus comprising:
the short optical pulse generating apparatus according to claim 3;
a photoconductive antenna to which the short optical pulse that is generated in a short optical pulse generating apparatus is which applied and causes terahertz waves to be generated;
a terahertz wave detecting portion that detects the terahertz waves that are emitted from the photoconductive antenna and permeate an object or the terahertz waves that are reflected on an object; and
a measuring portion that measures the object based on a detection result of the terahertz wave detecting portion.
